(19) United States
(12) Patent Application Publication
(10) Pub. No.: US 2016/0094619 A1
(43) Pub. Date: Mar. 31, 2016

(54) TECHNOLOGIES FOR ACCELERATING COMPUTE INTENSIVE OPERATIONS USING SOLID STATE DRIVES

(71) Applicants: JAWAD B. KHAN, Cornelius, OR (US); KNUT R. GRIMSRUD, Forest Grove, OR (US); RICHARD L. COULSON, Portland, OR (US)

(72) Inventors: JAWAD B. KHAN, Cornelius, OR (US); KNUT R. GRIMSRUD, Forest Grove, OR (US); RICHARD L. COULSON, Portland, OR (US)

(21) Appl. No.: 14/498,030

(22) Filed: Sep. 26, 2014

(51) Int. Cl. H04L 29/08; H04L 29/06

(52) U.S. Cl. CPC H04L 67/10; H04L 67/42

(57) ABSTRACT

Technologies for accelerating compute intensive operations such as encryption, decryption, encoding, decoding, etc. are described. In some embodiments the technologies leverage a hardware acceleration engine in or associated with one or more solid state drives to perform compute intensive operations, e.g. on behalf of server or other computing base. Systems, methods and computer readable media utilizing such technology are also described.

### TECHNICAL FIELD

The present disclosure relates to technologies for accelerating compute intensive operations. In particular, the present disclosure relates to technologies for accelerating compute intensive operations with one or more solid state drives.

### BACKGROUND

Compute intensive operations such as encryption, decryption, compression/decompression, hash computation, low level image processing algorithms (such as but not limited to filters, thresholding, etc.), DNA sequence matching and search algorithms, encoding, decoding algorithms, etc. can require significant central processing unit (CPU) cycles and/or other resources to complete. As the need for and complexity of compute intensive operations have increased, technologies have been developed to offload the performance of such operations from the CPU to dedicated hardware. For example, stand-alone encryption and decryption accelerators have been developed to perform compute intensive encryption and decryption operations. Such accelerators may be designed for the specific performance of certain encryption and decryption operations, and therefore in many cases they can perform such operations faster than a general purpose processor. They may also reduce the number of CPU cycles needed to perform such operations, and thus may free up the CPU for other operations even when encryption, decryption, or other compute intensive operations are being performed by the accelerator. Although effective for their intended purpose, stand-alone hardware accelerators can be quite costly. Indeed the cost of stand-alone hardware accelerators can be prohibitive in some instances, e.g., when a plurality of stand-alone hardware accelerators are to be used in a server (also referred to herein as a “host system”) that is configured to provide accelerated compute services to one or more clients.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a block diagram of a system for accelerating compute intensive operations consistent with the present disclosure;

FIG. 2 is a more detailed block diagram of the system of FIG. 1, consistent with various embodiments of the present disclosure;

FIG. 3 is a block diagram showing further details of a server and a solid state drive array consistent with various embodiments of the present disclosure.

FIG. 4 is a flow chart of example operations consistent with an example method of accelerating compute intensive operations consistent with the present disclosure.

FIGS. 5A and B depict additional system configurations consistent with various embodiments of the present disclosure.

### DETAILED DESCRIPTION

While the present disclosure is described herein with reference to illustrative embodiments for particular applications, it should be understood that such embodiments are exemplary only and that the invention as defined by the appended claims is not limited thereto. Those skilled in the relevant art(s) with access to the teachings provided herein will recognize additional modifications, applications, and embodiments within the scope of this disclosure, and additional fields in which embodiments of the present disclosure would be of utility.

The technologies described herein may be implemented using one or more devices, e.g., in a client-server architecture. The terms “device,” “devices,” “electronic device” and “electronic devices” are interchangeably used herein to refer individually or collectively to any of the large number of electronic devices that may be used as a client and/or a server consistent with the present disclosure. Non-limiting examples of devices that may be used in accordance with the present disclosure include any kind of mobile device and/or stationary device, such as but not limited to cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary.

The terms “client” and “client device” are interchangeably used herein to refer to one or more electronic devices that may perform client functions consistent with the present disclosure. In contrast, the terms “server” and “server device” are interchangeably used herein to refer to one or more electronic devices that may perform server functions consistent with the present disclosure. In some embodiments the server devices may be in the form of a host system that is configured to provide one or more services (e.g., compute acceleration services) to another device such as a client. In such embodiments the server devices may form part of, include, or be in the form of a data center or other computing base. The term “host system” is interchangeably used herein with the terms “server” and “server device.”

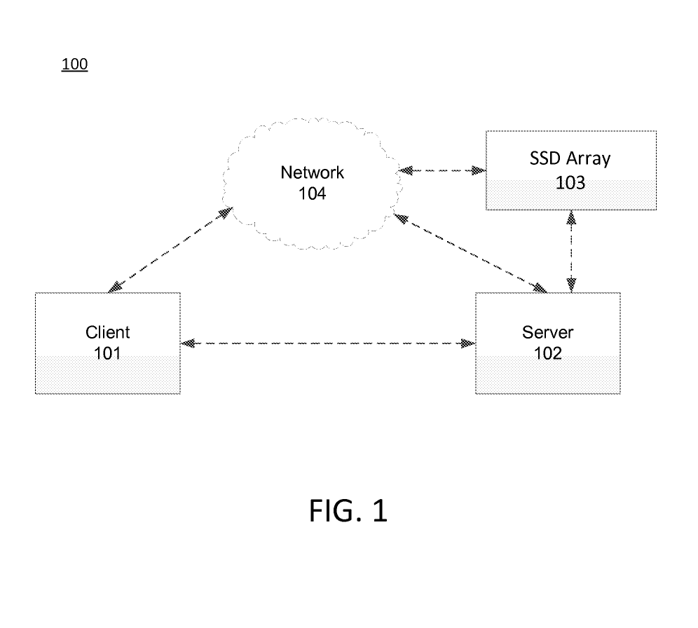

FIGS. 1-3 illustrate exemplary systems in accordance with the present disclosure as including a single client and a single server. Such illustrations are for the sake of example, and it should be understood that any number of clients and servers may be used. Indeed, the technologies described herein may be implemented with a plurality (e.g., 2, 5, 10, 20, 50, 100, 1000, 10,000 or more) client and/or server devices. Moreover the number of servers need not correlate to the number of clients. Indeed in some embodiments the technologies described herein utilize relatively few (e.g., 1 or 2) servers to support and/or provide compute acceleration services to a relatively large number (e.g., 100, 1000, 10,000) etc. of clients. Therefore while the present disclosure may refer to a client and/or a server in the singular, such expressions should be interpreted as also encompassing the plural form. Similarly, the designation of a device as a client or server is for clarity, and it should be understood that in some embodiments a client device may be configured to perform server functions, and a server device may be configured to perform client functions consistent with the present disclosure.

As used in any embodiment herein, the term “module” may refer to software, firmware, circuitry, and/or combinations thereof that is/are configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, data machine circuitry, software and/or firmware that stores instructions executed by programmable circuitry. The modules may, collectively or individually, be embodied as circuitry that forms a part of one or more electronic devices, as defined previously. In some embodiments one or more modules described herein may be in the form of logic that is implemented at least in part in hardware to perform one or more client and/or server functions consistent with the present disclosure.

The phrase “close range communication network” is used herein to refer to technologies for sending/receiving data signals between devices that are relatively close to one another, i.e., via close range communication. Close range communication includes, for example, communication between devices using a BLUETOOTH™ network, a personal area network (PAN), near field communication, a ZigBee network, a wired Ethernet connection, combinations thereof, and the like. In contrast the phrase “long range communication network” is used herein to refer to technologies for sending/receiving data signals between devices that are a significant distance away from one another, i.e., using long range communication. Long range communication includes, for example, communication between devices using a WiFi network, a wide area network (WAN) (including but not limited to a cell phone network (3G, 4G, etc. and the like), the internet, telephony networks, combinations thereof, and the like.

The terms “SSD,” “SSDs” and “solid state drive” are interchangeably used herein to refer to any of the wide variety of data storage devices in which integrated circuit assemblies (e.g., non-volatile random access memory (RAM) assemblies) are used to store data persistently. Such terms also encompass so-called “hybrid” drives, in which a solid state drive may be used (e.g., as cache) in combination with a hard disk drive, e.g., which includes a magnetic recording medium. In any case, an SSD may be understood to include non-volatile memory such as but not limited to flash memory such as negated and not and (NAND) and/or not or (NOR) memory, phase change memory (PCM), three dimensional cross point memory, resistive memory, nanowire memory, ferro-electric transistor random access memory (FeTRAM), magnetoresistive random access memory (MRAM) memory that incorporates memristor technology, spin transfer torque (STT)-MRAM, combinations thereof, and the like.

The phrase “compute intensive operations” is used herein to refer to any of a wide variety of computing operations that may require significant processor cycles to complete. Non-limiting examples of compute intensive operations include encryption, decryption, compression/decompression, hash computation, low level image processing algorithms (such as but not limited to filters, thresholding, etc.), DNA sequence matching and search algorithms, encoding algorithms, decoding algorithms, combinations thereof, and the like. Of course the aforementioned operations are examples only, and other compute intensive operations are envisioned and encompassed by the present disclosure.

As noted in the background standalone hardware accelerators have been developed and implemented to accelerate compute intensive operations such as data encryption/decryption, video encoding/decoding, network packet routing, etc. Although such standalone hardware accelerators may be effective for their intended purpose, they can be quite expensive. Standalone hardware accelerators can therefore represent a significant portion of the cost of server or other computing base that is configured to provide compute acceleration services (e.g., accelerated encryption, decryption, etc.) for one or more clients, particularly if the server is to include a plurality of such accelerators. Moreover, performance of compute intensive operations may not scale well with certain standalone hardware accelerators. That is in some instances, increasing the number of standalone hardware accelerators may not result in a corresponding (e.g., 1:1) increase in the performance of compute intensive operations.

Electronic devices are increasingly being equipped with solid state drives, which are generally used for data storage. With this in mind, SSDs include a hardware-based controller (hereinafter, “SSD controller”) that includes a high bandwidth (e.g., multi-gigabyte per second) hardware encryption/decryption engine. Although the hardware encryption/decryption engine of an SSD is capable of performing various operations at high speed, in many instances it is configured to perform data at rest encryption and/or decryption, and/or to encrypt/decrypt data as part of the drive's normal read/write flow. For example, some SSD's may include a hardware encryption/decryption engine that is configured to encrypt/decrypt data stored on the SSD with one or more encryption algorithms, such as but not limited to the Advanced Encryption Standard (AES) algorithm specified in FIPS Publication 197 and/or ISO/IEC 18033-3. With existing technology, the hardware encryption/decryption engines of an SSD may perform encryption/decryption of data many times faster than such encryption/decryption could be performed in software (e.g., executed by a general purpose processor of a client or server).

Although the performance of the hardware encryption/decryption engine of many SSDs is interesting, in a typical system the SSD controller and in particular the SSD controller's hardware encryption/decryption engine is not available to the client and/or server device, e.g., for the performance of data encryption/decryption or other compute intensive operations. That is unlike standalone hardware accelerators, the hardware encryption/decryption engine of an SSD is generally not directly accessible by a host system (client or server) for the performance of compute intensive operations.

With the foregoing in mind the present disclosure generally relates to technologies for accelerating compute intensive operations that capitalize on one or more hardware acceleration engines that are present in many SSDs. In particular and as will be described below, the technologies described herein can expose the hardware acceleration engines of an SSD to a host system. As a result the host system may use the SSD's hardware acceleration engine(s) to accelerate compute intensive operations such as those identified above. As will become clear from the following, use of the hardware acceleration engine in this manner need not compromise the solid state drive's traditional data storage function. Moreover in some embodiments acceleration of compute intensive operations by the technologies described herein may scale with the number of SSDs.

One aspect of the present disclosure therefore relates to systems for accelerating compute intensive operations. For the sake of clarity and ease of understanding, the present disclosure will proceed to describe various embodiments in which the compute intensive operation to be accelerated is the performance of an encryption/decryption algorithm, or some portion thereof. It should be understood that the technologies described herein are not limited to accelerating encryption/decryption operations, and that they may be used to accelerate any suitable type of compute intensive operation including but not limited to those noted above and/or any portion thereof.

In this regard reference is made to FIG. 1, which is a block diagram of an example system for accelerating compute intensive operations consistent with the present disclosure. As shown, system 100 includes client 101, server 102, and solid state drive (SSD) array 103.

Client 101 may be any suitable electronic device, as defined above. Without limitation, in some embodiments client 101 is in the form of one or more cellular phones, desktop computers, electronic readers, laptop computers, set-top boxes, smart phones, tablet personal computers, televisions, or ultra-mobile personal computers. Regardless of its form, in some embodiments client 101 (or an operator thereof) may have a compute intensive operation (also referred to herein as a “job”) for which acceleration is desired. For example, client 101 (or an operator thereof) may wish to have a set of data encrypted. In such instances and as will be described in detail below, client 101 may be configured to communicate all or a portion of the job (in the example case, all or a portion of the data for encryption) to server 102 for acceleration.

Like client 101, server 102 may be any suitable electronic device. Without limitation, server 102 in some embodiments is in the form of one or more server computers, such as one or more blade servers, rack mount servers, combinations thereof, and the like. In some example embodiments server 102 is a standalone server. In other example embodiments server 102 may be one or more servers in an array of servers, such as may be found in a data center or other aggregated computing base. In any case server 102 may be configured to receive a job from client 101 for acceleration, and to transmit the job to one or more SSDs of SSD array 103 for acceleration. In particular and as will be described below, server 102 may be configured to transmit all or a portion of a job received from client 101 to at least one SSD of SSD array 103, so as to cause a hardware acceleration engine of the SSD to perform at least a portion of the job. Server 102 may then retrieve or otherwise receive the output of the operations performed by the hardware acceleration engine, and communicate that output to client 101.

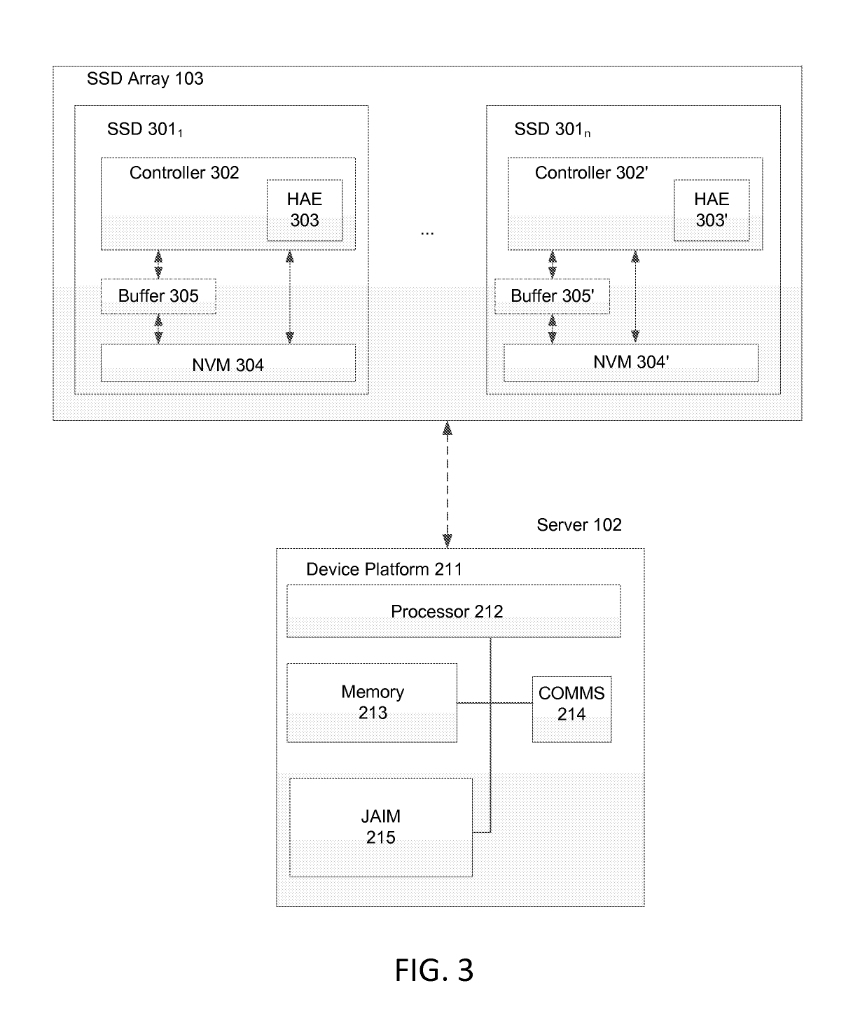

SDD array 103 may include one or more solid state drives. For the sake of example, the present disclosure describes various embodiments in which SSD array includes one SSD or two SSD's (as shown in FIG. 3, for example). It should be understood that such description is for the sake of example only, and that any number of SSD's may be used. Indeed, the present disclosure envisions embodiments in which a plurality of SSDs are included in SSD array 103, e.g., in which SSD 103 includes from greater than or equal to about 2, about 5, about 10, about 100, about 1000 or more SSD's. Again such ranges are for the sake of example only.

The SSD's of SSD array 103 may be in any suitable form factor or configuration. Non-limiting examples of suitable SSD form factors include SSD's that are in any of the variety of standard hard disk drive form factors (e.g., 2.5 inch, 3.5 inch, 1.8 inch), mobile form factors such as mobile serial advanced technology attachment form factor, peripheral connect interface (PCI) mini card form factor, a disk on a module form factor, a hybrid disk form factor, combinations thereof, and the like. In some embodiments one or more of the SSD's in SSD array 103 is an SSD sold by INTEL® corporation, e.g., under the series 300 or higher designation.

For the sake of illustration and ease of understanding, FIGS. 1, 2 and 3 depict systems in which SSD array 103 is illustrated as being separate from server 102. In such instances it may be understood that SSD array 103 may be part of a computing base that is separate from but accessible by server 102. Thus for example, SSD array 103 may form part of, be in the form of, or include a computing base that is separate from server 102. That is, SSD array 103 may be housed in the same or different data center, server farm, housing, etc. from server 102. Of course it should be understood that such illustration is for the sake of example only, and that SSD array may be integral with or otherwise form a part of server 102. For example, server 102 may include one or more rack mount and/or blade servers which include or are otherwise integral with SSD array 103. In such embodiments one or more of the SSD's in SSD array 103 may be communicatively coupled to server 102, e.g., to a motherboard and/or expansion board thereof.

Client 101, server 102, and solid state drive array 103 may be in wired or wireless communication with one another, e.g., either directly or through optional network 104 (shown in hashes). Without limitation, client 101 and server 102 in some embodiments communicate with one another via network 104, and server 102 and SSD array 103 communicate with one directly or through network 104. In any case, network 104 may be any network that carries data. Non-limiting examples of suitable networks that may be used as network 104 include short and long range communications networks as defined above, combinations thereof, and the like. In some embodiments, network 104 is a short range communications network such as a BLUETOOTH® network, a zig bee network, a near field communications (NFC) link, a wired (e.g., Ethernet) connection, combinations thereof, and the like. In other embodiments, network 104 is a long range communications network such as a Wi-Fi network, a cellular (e.g., 3G, 4G, etc.) network, a wide area network such as the Internet, combinations thereof and the like.

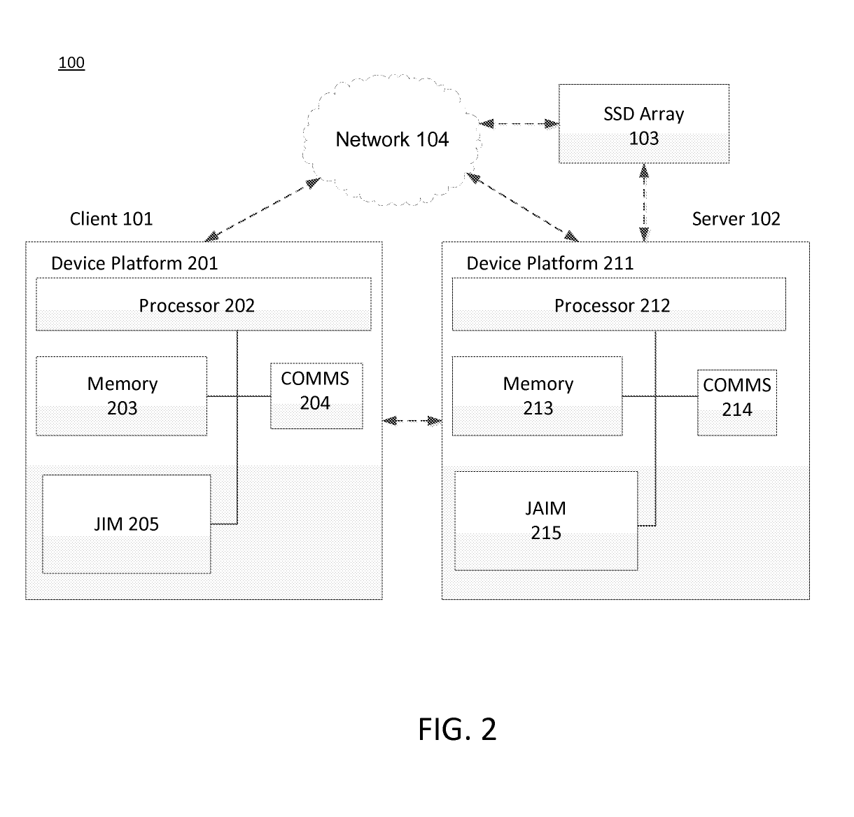

Reference is now made to FIG. 2, which depicts a block diagram including more details of system 100 for accelerating compute intensive operations. As shown, client 101 includes client device platform 201, which may be any suitable device platform. Without limitation it is preferred that client device platform 201 correlate to the type of electronic device used as client 101. Thus for example where client 101 is a cellular phone, smart phone, desktop computer, laptop computer, etc., client device platform 201 in some embodiments is a cellular phone platform, smart phone platform, desktop computer platform, laptop computer platform, etc. respectively.

Regardless of its nature, device platform 201 may include processor 202, memory 203, and communications resources (COMMS) 204. Processor 202 may be any suitable general purpose processor or application specific integrated circuit, and may be capable of executing one or multiple threads on one or multiple processor cores. Without limitation, processor 202 is in some embodiments a general purpose processor, such as but not limited to the general purpose processors commercially available from INTEL® Corp., ADVANCED MICRO DEVICES®, ARM®, NVIDIA®, APPLE®, and SAMSUNG®. While FIG. 2 illustrates client 101 as including a single processor, multiple processors may be used.

Memory 203 may be any suitable type of computer readable memory. Exemplary memory types that may be used as memory 203 include but are not limited to: programmable memory, non-volatile memory, read only memory, electrically programmable memory, random access memory, flash memory (which may include, for example NAND or NOR type memory structures), magnetic disk memory, optical disk memory, phase change memory, memristor memory technology, spin torque transfer memory, combinations thereof, and the like. Additionally or alternatively, memory 203 may include other and/or later-developed types of computer-readable memory.

COMMS 204 may include hardware (i.e., circuitry), software, or a combination of hardware and software that is configured to allow client 101 to at least transmit and receive messages to/from server 102 or, more particularly COMMs 214 of server device platform 211, as discussed below. Communication between COMMS 204 and COMMS 214 may occur over a wired or wireless connection using a close and/or long range communications network as described generally above. COMMS 204 may therefore include hardware to support such communication, e.g., one or more transponders, antennas, BLUETOOTH™ chips, personal area network chips, near field communication chips, wired and/or wireless network interface circuitry, combinations thereof, and the like.

Client device platform 201 further includes a job interface module (JIM) 205. As will be described in detail later, JIM 205 may be configured to batch and/or send (compute intensive) jobs to server 102 for execution. In any case, JIM 205 may be in the form of hardware, software, or a combination of hardware and software which is configured to cause client 101 to perform job request operations consistent with the present disclosure. In some embodiments, JIM 205 may be in the form of computer readable instructions (e.g. stored on memory 203) which when executed by processor 202 causes the performance of job request operations consistent with the present disclosure. Alternatively or additionally, in some embodiment JIM 205 may include or be in the form of logic that is implemented at least in part in hardware to perform one or more client functions consistent with the present disclosure.

As further shown in FIG. 2, server 102 includes server device platform 211. Like client device platform 201, server device platform 211 may be any suitable device platform. Without limitation it is preferred that server device platform 211 correlate to the type of electronic device used as server 102. Thus for example where server 102 is a rack mount server platform, a blade server platform, a desktop computer platform, etc., server device platform 211 is in some embodiments a rack mount server platform, a blade server platform, a desktop computer platform, etc., respectively. Server device platform 211 further includes a processor 212, memory 213, and COMMS 214. The nature and function of such components is the same as the corresponding parts of client device platform 201, and therefore is not described again for the sake of brevity.

In addition to the foregoing components device platform 211 includes job acceleration interface module (JAIM) 215. As will be described in detail below, JAIM may generally be configured to receive (compute intensive) jobs from client 101, and to convey such jobs to one or more SSDs of SSD array 103 for execution. JAIM may also be configured to receive and/or retrieve the output produced by SSD array 103, and to communicate the output to client 101. In this way, JAIM 215 may expose the hardware acceleration engine of an SSD to server 102, and therefore allow server 102 to leverage such hardware to perform compute intensive operations.

Like JIM 205, JAIM 215 may be in the form of hardware, software, or a combination of hardware and software which is configured to cause server 102 to perform job acceleration interface operations consistent with the present disclosure. Such operations may include, for example, receiving a job request and/or data from client 101, producing one or more job execution commands, transmitting the job execution command(s) to SSD array 103, requesting in some embodiments) the output produced by SSD array (or an SSD thereof), and transmitting the output to client 101, as discussed below. In some embodiments, JAIM 215 may be in the form of computer readable instructions (e.g. stored on memory 213) which when executed by processor 212 causes the performance of job acceleration interface operations consistent with the present disclosure. Alternatively or in addition, JAIM 215 in some embodiments may include or be in the form of logic that is implemented at least in part in hardware to perform one or more server functions consistent with the present disclosure.

In some embodiments JAIM 215 may be configured to communicate with SSD array 103 in accordance with an established communication protocol, such as past, present or future developed versions of the serial advanced technology attachment (SATA) protocol, the non-volatile memory express (NVMe) protocol, the serial attached small computer systems interface (SAS) protocol combinations thereof, and the like. Such protocols have options to define vendor specific commands which can be used to describe and/or implement the commands described herein as being issued by JAIM 215, e.g., the job execution commands not above. It should therefore be understood that the commands issued by JAIM 215 may be vendor specific commands that comply with one or more of the aforementioned protocols.

As noted above, SDD array 103 may include one or more solid state drives. This concept is illustrated in FIG. 3, which is a block diagram showing further details of a server and a solid state drive array consistent with various embodiments of the present disclosure. As shown in FIG. 3, SSD array 103 may be configured to include a SSD 301_{1 . . . n}, wherein n is 0 (indicating that only a single SSD is used) or is an integer greater than or equal to 2. Consistent with the foregoing, n may range from 2 to about 5, from 2 to about 10, from 2 to about 50, from 2 to about 100, from 2 to about 1000, etc. Without limitation, SSD array 103 in some embodiments includes 2 or more SSDs.

SSDs 301₁, 301ₙ may each include a controller 302, 302′. As further shown in FIG. 3, each controller 301₁, 301ₙ may include a hardware acceleration engine (HAE) 303, 303′. In general, HAE 303, 303′ may be configured to perform accelerated operations on data, also referred to herein as data. More specifically, HAE 303, 303′ may be configured to perform accelerated compute intensive operations on data/data that is stored on SSD 301, 301′ (e.g., in non-volatile memory (NVM) 304, 304′), and/or which may be received from server 102. In some embodiments, HAE 303, 303′ is configured in the form of a field programmable gate array (FPGA), an application specific integrated circuit, an encryption/decryption acceleration engine, a compression/decompression engine, an encode/decode engine (CODEC) combinations thereof, and the like, any or all of which may include an interface in the form of hardware, software, or a combination thereof. Without limitation, HAE 303, 303′ is in some embodiments in the form of a hardware encryption/decryption engine. Non-limiting examples of suitable hardware encryption/decryption engines include the hardware encryption engines available in certain SSDs sold by INTEL® Corporation, such as but not limited to the INTEL® P3700 series SSD. In some embodiments, HAW 303, 303′ is a hardware encryption/decryption engine that is configured to accelerate execution of one or more encryption algorithms (e.g., the AES algorithm specified by FIPS 197) on a data.

As will be described in detail later, controller 302 may receive a job execution command associated with data/data from JAIM 215, e.g., via wired or wireless communication. In response to the job execution command, controller 302 may forward the data to HAE 303 for processing in accordance with the job request. HAE 303 may process the data in the manner specified by the job execution command, e.g., by performing accelerated compute intensive operations on the data. Depending on the configuration of SSD 301₁, 301ₙ and/or on the configuration of the received job execution command, the output produced by HAE may be communicated to server 102, e.g., in a flow through manner. That is, in some embodiments the output may be forwarded to server 102 without the need for server 102 to request the output.

Alternatively or additionally, in some embodiments the output of HAE 303, 303′ may be stored in a memory of SSD 301₁, 301ₙ, such as NVM 304, 304′ or optional transfer buffer 305, 305′. Optional transfer buffer 305, 305′ may be any suitable transfer buffer, and in some embodiments includes or is in the form of volatile memory such as dynamic random access memory (DRAM) or static random access memory or SRAM.

Without limitation, in some embodiments SSD 301₁, 301ₙ includes optional transfer buffer 305, 305′, and the job execution command received from JAIM 215 is configured to cause controller 302, 302′ (or, more particularly, HAE 303, 303′) to store its output in transfer buffer 305. In such instances, JAIM 215 may be further configured to cause server 102 to issue an output request message (e.g., a read buffer command) to SSD 301₁, 301ₙ, causing SSD array 103 to provide the output of HAE 303, 303′ to server 102.

For the sake of illustration the present disclosure will now proceed to describe an example embodiment in which the system illustrated in FIGS. 1-3 is used to perform accelerated encryption operations. In this regard is it noted that client 101 and/or an operator thereof may wish to encrypt a data set (data) with an encryption algorithm such as the advanced encryption standard. In this regard, JIM 205 may be configured to cause COMMS 204 of client 101 to transmit a first signal to COMMS 214 of server 102. In some embodiments the first signal may include a job acceleration request. Among other things, the job acceleration request may specify parameters of the job to be accelerated.

Non-limiting example of such parameters include the size of the data, the operations to be performed on the data (in this case, encryption, though other compute intensive operations are envisioned)), the type of encryption to be employed (e.g., AES encryption, SMS4 encryption, etc.), one or more keys that are to be used in the encryption, combinations thereof, and the like. Of course the foregoing list is for the sake of example, and it should be understood that the operations to be accelerated may depend on the encryption algorithm under consideration. In some embodiments, the first signal may also include one or more keys and/or specify one or more algorithms that are to be used in the processing of the data. For example where the data is to be encrypted using a single key encryption protocol, the first signal may include the key that is to be used by the HAE to encrypt the data. Alternatively or additionally, each of SSDs 301₁, 301ₙ may have been pre-provisioned with a key that is to be used to encrypt the data.

The first signal may also include information regarding client 101. For example, the first signal may include client authentication information that may be used by server 102 to verify the authenticity of client 101. Non-limiting examples of suitable client identification information include an identifier of client 101, one or more passwords, one or more keys (e.g., client 101's enhanced privacy identifier (EPID)), one or more hashes, combinations thereof, or the like. These are of course for the sake of example only, and any suitable information may be included in the first signal as client authentication information, so long as it may enable server 102 to verify the authenticity of client 101. In this regard, server 102 may verify the authenticity of client 101 via any suitable authentication protocol.

Once the authenticity of the client has been verified or if such verification is not required JAIM 215 may cause server 102 to transmit a second signal to client 101, e.g., using COMMS 214. In some embodiments the second signal may acknowledge the first signal and cause client 101 to transmit the data to server 102, either directly or via network 104.

At this point JAIM 215 may await receipt of the entire data from client 101 before beginning the job, or it may begin the job while the data is being received, e.g., as it is in-flight or streaming to server 102. In any case, JAIM 215 may initiate performance of the job (in this case, encryption of the data), by transmitting a third signal to SSD array 1003. The third signal may include a job execution command detailing the operations to be performed on the data, as well as the data to be processed by one or more of the SSDs in SSD array 103. In this example case for example, the third signal may include a job execution command that specifies the type of encryption operations to be performed, as well as a description of the data on which encryption is to be performed. As noted above, the job execution command may be in the form of a vendor specific command in accordance with one or more previous, current, or future developed versions of the SATA, NVMe, and/or SAS protocols.

In response to the job execution command the controllers of the SSDs in SSD array 103 may be configured to transmit all or a portion of the data they receive to a hardware acceleration engine (e.g., HAE 303, 303′) for processing. For example HAE 303 may process the received data in a manner consistent with the operations specified in the job execution command received from server 102 or, more specifically, from the commands produced by controller 302 in response to the job execution command received from server 102. In this example, HAE 303 may be a hardware encryption engine, such as may be employed in various commercially available SSD's. Thus, where the data received by an SSD is to be encrypted (e.g., using the advanced encryption standard or another suitable encryption algorithm) controller 302, 302′ may supply all or a portion of the data to HAE 303, 303′. In response, HAE 303, 303′ may perform hardware accelerated encryption on the data to produce an output. Like the job execution command, the commands issued by the controllers in the SSDs of SSD array 103 may be in the form of vendor specific commands, e.g., in accordance with one or more prior, current, or future developed version of the SATA, NVM, and/or SAS protocols.

In some embodiments JAIM 215 may cause server 102 to produce a job execution command that includes, is associated with, or is in the form of a (optionally vendor specific) read/write command issued to a controller (e.g., controller 302, 302′) of an SSD (e.g., SSD 301₁, 303ₙ) of SSD array 103. In such instance the job execution command may cause the controller to instigate performance of the requested operations by a hardware acceleration engine (e.g., HAE 303, 303′), in addition to reading and/or writing the data and/or the output to non-volatile memory. That is in response to the job execution command, the output of HAE 303, 303′ may be written to non-volatile memory of the SDD (e.g., NVM 304, 304′). Alternatively or additionally, the output may be written to a buffer (e.g., optional buffer 305, 305′) of the SSD. In either case, once the output is written controller 302 may transmit a signal to server 102 signifying that execution of the job is complete. In response to such a signal, JAIM 215 may cause server 102 to request transmission of the output from controller 302. Thus for example, JAIM 215 may cause server 102 to issue a request output command to an appropriate SSD of SSD array 103. The request output command may be configured to cause the controller of the SSD to read the output of the operations performed by a hardware acceleration engine, and to transmit that output to server 102. Like the job execution command, the request output command may be a vendor specific command in accordance with one or more SAT, NVMe, and/or SAS protocols. Server 102 may then communicate the output to client 101, e.g., via wired or wireless communication.

More generally, in some embodiments JAIM 215 may configure the job execution command as part of a read/write command that causes controller of an SSD to transmit data received in association with a job to a hardware acceleration engine for processing. In response to the job execution command, the hardware acceleration engine may perform compute intensive operations on the data, e.g., encryption, decryption, etc., and produce an output which is stored in a memory of the SSD, such as non-volatile memory, a buffer/cache, combinations thereof, and the like. Without limitation, the job execution command is in some embodiments configured to cause the SSD controller to store the output produced by a hardware acceleration engine in a buffer of the SSD. In either case, JAI 215 may cause server 102 to issue a request output command to an appropriate SSD of SSD array 103. The request output command may include or be in the form of a read command (e.g., a read non-volatile memory command, a read buffer command, combinations thereof, and the like) that causes the controller of the SSD to read the output stored in non-volatile memory and/or a buffer/cache of the SSD, and provide the read output to server 102. JAI 215 may then cause server 102 to communicate the job output to client 101.

In other non-limiting embodiments, JAIM 215 may cause server 102 to produce a job execution command that is not associated with a read/write command. Like the previous embodiments, the job execution command may be configured to cause controller a controller of an SSD to transmit data received in association with a job to a hardware acceleration engine for processing. Unlike the previous embodiments, however, the job execution command may not cause the controller to store the output of the hardware acceleration engine in a buffer or non-volatile memory. Rather, the job execution command may cause the controller to automatically convey the output of the hardware acceleration engine to the server or, more particularly, to JAIM 215, without storing the output in non-volatile memory. That is, unlike the previous embodiments server 102 (or, more particularly, JAIM 215) need not request the output from the hardware acceleration engine. Rather, each SSD may automatically provide the output from the hardware acceleration engine to server 102 (or, more particularly, to JAIM 215). In such embodiments it may be understood that the SSDs in SSD array 103 may act purely as accelerators for the compute intensive operations associated with the job execution command, with data/data being input to and output from one or more SSDs in the array in a flow through manner. In response to receiving the output, server 102 may then communicate the output to client 101, e.g., via wired or wireless communication.

It is noted that for the sake of example and illustration, FIG. 3 depicts an embodiment in which hardware acceleration engine 303, 303′ is integral with the controller (e.g., controller 302, 302′). It should be understood that such illustration is for the sake of example only, and that HAE 303, 303′ need not be integral with controller 302, 302′, respectively. Indeed, the present disclosure envisions embodiments in which a hardware acceleration engine is formed as a separate component that is internal to an SSD, as well as embodiments in which a hardware acceleration engine is external to an SSD to but is ultimately controlled by an SSD controller.

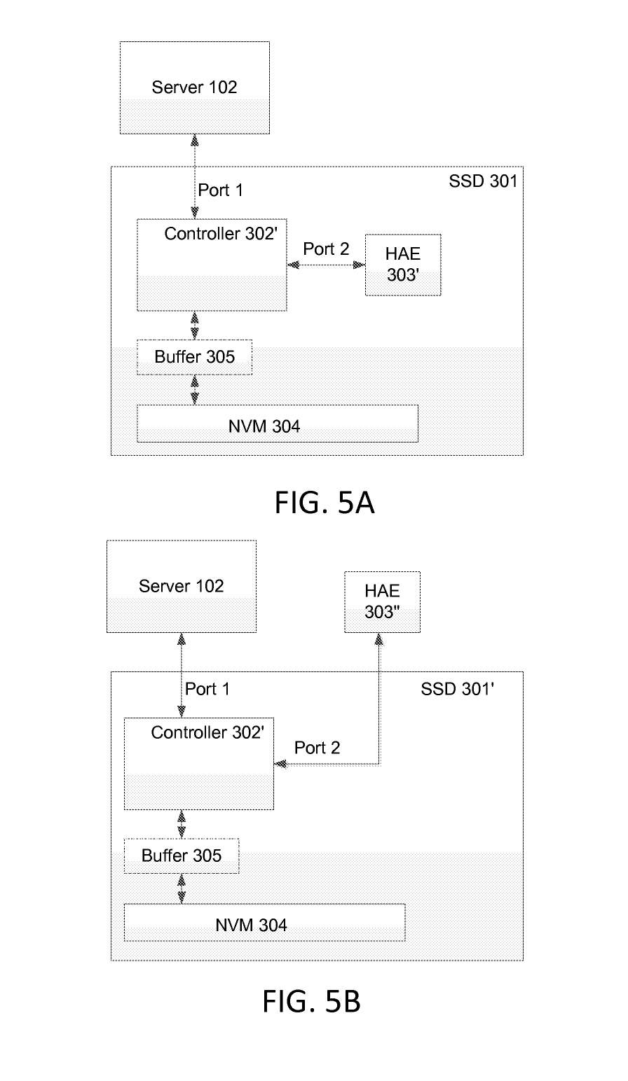

For example in some embodiments controller 302, 302′ may be in the form of a multi-port controller such as a dual port controller. In such embodiments a first port of the controller may be communicatively coupled to server 102, e.g., via an appropriate interface such as a cable interface. Another (e.g., second) port of the controller may be communicatively coupled to the hardware acceleration engine, which as noted above may be separate from the controller, and either separate from or internal to the SSD. These concepts are illustrated in FIGS. 5A and B. Specifically, FIG. 5A depicts an example embodiment in which SSD 301 includes a dual port controller 302′, wherein a first port of controller 302′ is coupled to server 102, and a second port of controller 302′ is coupled to a hardware acceleration engine 303′ that is separate from controller 302′, but which it integral with SSD 301. SSD 301′ in FIG. 5B includes similar elements, except that the second port of controller 302′ is coupled to a hardware acceleration engine 303″ that is external to SSD 301′. It should be understood that in FIGS. 5A and 5B, SSDs 301 and 301′ may be used in the same manner as SSDs 301_{1 . . . n} in FIG. 3. It should also be understood that the depiction of SSDs 301 and 301′ in FIGS. 5A and B as being separate from server 102 is for the sake of example, and that such SSDs may be integral with or otherwise incorporated within server 102. Finally, it should be understood that HAEs 303′ and 303″ may be used in the same manner as HAE 303 in FIG. 3, and that HAE 303″ may in some embodiments be integral with or otherwise incorporated within server 102.

The operation of the embodiments of FIGS. 5A and 5B is the same as previously described above in connection with FIGS. 1-3, except for the relative location of the hardware acceleration engine. As may be appreciated such embodiments may provide certain advantages relative to the embodiments shown in FIG. 3, i.e., in which a hardware acceleration engine is integral to the SSD controller. Specifically, the embodiments of FIG. 3 may entail significant upfront design and validation efforts to ensure that the accelerator is working correctly in conjunction with the controller. With this in mind, the alternatively approaches noted above can avoid such issues, and provide another pathway in instances where integrating the accelerator with the controller is difficult or not an option.

For ease of understanding the foregoing embodiment was described in the context of a solid state drive array that includes one or relatively few SSDs. It should be noted that such description is for the sake of example only, and that the technologies described herein may be batched and/or scaled between multiple SSDs. Indeed depending on the operations to be performed, the size of the data, and/or other factors, the third signal may be configured to cause SSD array 103 to process the data with one or a plurality of the SSDs therein. For example where the size of the data is relatively small or the operations to be performed on the data are relatively simple, JAIM 215 may configure the third signal to cause SSD array 103 to process the entire data with a single SSD. Alternatively where the data is relatively large and/or even faster performance of the operations on the data is desired, JAIM 215 may configure the third signal to cause SSD array 103 to subdivide the data amongst a plurality of SSDs, such that each SSD operates on a portion of the data.

For example in some embodiments and as shown in FIG. 3, SSD array 103 may include a plurality of SSDs, including at least a first solid state drive (e.g., SSD 301₁) and a second solid state drive (301₁). In such embodiments and as shown in FIG. 3, the first solid state drive may include a first controller, a first hardware acceleration engine, and first non-volatile memory, and the second solid state drive may comprise a second controller, a second hardware acceleration engine, and a second non-volatile memory.

With this in mind, JAIM 215 of server 102 may be configure to transmit a first job acceleration command and a first portion of said data to the first solid state drive, and a second job acceleration command and a second portion of the data to the second solid state drive. The first job acceleration command nay be configured to cause the first controller to transmit the first portion of said data to the first hardware acceleration engine for execution of first accelerated operations on the first portion of said data, e.g., as generally discussed above. For example, the first hardware acceleration engine may execute first accelerated operations on the first portion of the data without storing an output of the first accelerated operations in the first non-volatile memory. Likewise, the second job acceleration command may be configured to cause the second controller to transmit the second portion of said data to the second hardware acceleration engine for execution of second accelerated operations on the second portion of the data, e.g., as generally described above. In some embodiments, the second hardware acceleration engine may perform the second accelerated operations without storing an output of the second accelerated operations in the second non-volatile memory. In such embodiments, the first job acceleration command may further be configured to cause the first solid state drive to transmit the output of the accelerated operations performed on the first portion of the data to said JAIM, and the second job acceleration command may be further configured to cause the second solid state drive to transmit the output of the accelerated operations performed on the second portion of the data to said JAIM.

As noted above the first and second hardware acceleration engines of the first and second solid state drives may perform the first and second accelerated operations without storing their respective output to non-volatile memory of an SSD. Although such embodiments are useful, systems employing more than one solid state drive are not limited to that particular configuration. Indeed like the other embodiments described above, the first and second solid state drives may each include a first transfer buffer and a second transfer buffer, respectively. In such embodiments, the first and second hardware acceleration engines may store the output of the first and second operations in the first and second transfer buffers, respectively. JAIM 215 may then cause server 102 to issue one or more request output commands that cause the first and second solid state drives to provide the output in the first and second transfer buffers, respectively, to server 102 or, in instances where the solid state drives are integral with server 102, to other components of server 102. In any case, in response to a request output command the SSD's may provide the output from their respective transfer buffers to server 102 via any suitable interface. For example where an SSD is not integral with server 102, it may communicate the output via a suitable communications interface, such as via a long range communications network, a short range communications network, combinations thereof and the like. In instances where an SSD is integral with server 102, it may communicate the output via a communications protocol such as the Serial Advanced Technology Attachment (SATA) protocol, the peripheral component interconnect (PCI) protocol, the PCI express protocol

Of course, the technologies described herein are not limited to the use of an SSD array that includes one or two SSD's. Indeed from the foregoing one of ordinary skill in the art will appreciate that the technologies described herein may employ a large numbers of SSD's to process compute intensive operations on a data. That is, it may be understood that performance of the compute intensive operations may be scaled up or down by batching jobs to greater or fewer SSD's, as desired.

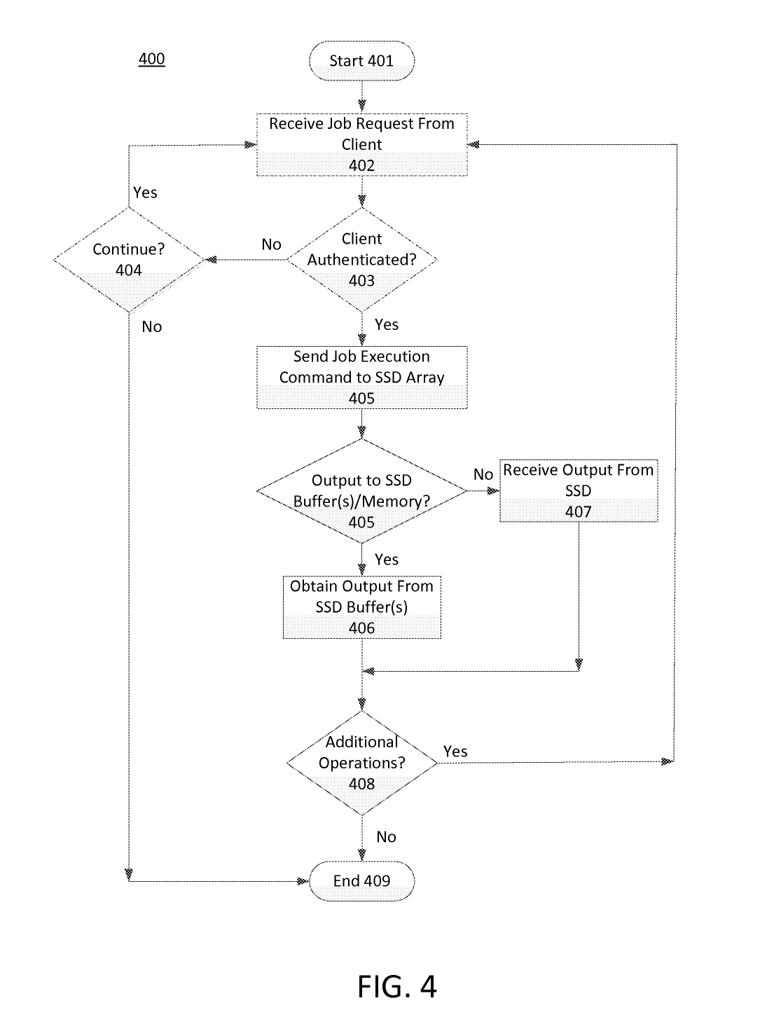

Another aspect of the present disclosure relates to methods for accelerating compute intensive operations. In this regard reference is made to FIG. 4, which is a flow diagram of example operations of one embodiment of a method of accelerating compute intensive operations consistent with the present disclosure. As shown the method begins at block 401. The method may then proceed to optional block 402, wherein a server may receive a job request from a client. Block 402 is illustrated with hashing to show its optional nature, as in some embodiments it is envisioned that the server itself may be the source of a job request. That is, in some embodiments a server may include a job interface module (e.g., such as JIM 205), which is configured to produce a first signal containing a job acceleration request.

The method may then proceed to optional block 403, wherein a determination may be made as to whether the client (or other entity producing the job acceleration request) is authenticated, e.g., as generally discussed above. If not, the method may proceed to optional block 404, wherein a determination may be made as to whether the method is to continue. If not, the method may proceed to block 409 and end. If so, the method may loop back to block 402 and continue.

If the client is authenticated pursuant to block 403 or if the operations of blocks 402 and/or 403 are not required, the method may proceed to block 405, wherein a job execution command may be produced and sent to an SSD array, e.g., in the manner generally discussed above. As previously discussed the job execution command may cause a controller of an SSD in the SSD array to send data associated with the command to a hardware acceleration engine for processing.

The method may then proceed to block 405, whereupon a determination may be made as to whether the hardware acceleration engine of an SSD in the SSD array is to produce an output that is stored in a buffer or memory of that SSD. As discussed previously, the output of the hardware acceleration engine of an SSD may be stored to a buffer and/or non-volatile memory of the SSD, e.g., in response to the job execution command (e.g., where the job execution command is included in, in the form of, or associated with a read/write command issued to the SSD controller. If the output is to be stored in a buffer or memory, the method may proceed to block 406, wherein the output may be obtained from the SSD buffer and/or memory, as appropriate. As discussed above this may be accomplished, for example, by the issuance of a read command (e.g., a read memory or read buffer command) issued by a server to a controller of the SSD. However if the output is not to be stored in a buffer or memory of an SSD the method may proceed to block 407, wherein the output may be received from the SSD automatically. That is pursuant to block 407, the party issuing the job execution command may automatically receive the output of the hardware acceleration engine of the SSD(s) in the SSD array, e.g., without the need to issue an additional command requesting the output.

In any case the method may then proceed to block 408, wherein a determination may be made as to whether there are additional compute intensive operations that are to be accelerated. If so, the method may loop back to block 402. If not, the method may proceed to block 409 and end.

### EXAMPLES

The following examples pertain to further embodiments. The following examples of the present disclosure may comprise subject material such as a system, a device, a method, a computer readable storage medium storing instructions that when executed cause a machine to perform acts based on the method, and/or means for performing acts based on the method, as provided below.

### Example 1

According to one example of the present disclosure there is provided a system for accelerating compute intensive operations including: at least one solid state drive including a controller, a hardware acceleration engine, and non-volatile memory, wherein the controller is configured to: transmit, in response to receipt of a job execution command from a server, data associated with the job execution command to the hardware acceleration engine for execution of accelerated operations on the data without storing an output of the accelerated operations in the non-volatile memory; and provide the output to the server.

### Example 2

This example includes any or all of the features of example 1, wherein: the at least one solid state drive further includes a transfer buffer; the controller is further configured to cause the hardware acceleration engine to store the output in the transfer buffer; and the controller is further configured to provide the output to the server in response to receipt of a request output message from the server.

### Example 3

This example includes any or all of the features of any one of examples 1 and 2, wherein the controller is further configured to cause the hardware acceleration engine to perform the accelerated operations in accordance with parameters of a job to be accelerated.

### Example 4

This example includes any or all of the features of any one of examples 1 to 3, wherein the parameters include at least one of the following: a size of the data, one or more operations to be performed on the data, combinations thereof, and the like.

### Example 5

This example includes any or all of the features of any one of examples 1 to 3, wherein the at least one solid state drive is included in an solid state drive array that is remote from the server.

### Example 6

This example includes any or all of the features of any one of examples 1 to 5, wherein the at least one solid state drive is integral with the server.

### Example 7

This example includes any or all of the features of any one of examples 1 to 6, wherein the controller is configured to automatically provide the output to the server.

### Example 8

This example includes any or all of the features of any one of examples 1 to 7, wherein the hardware acceleration engine is selected from the group consisting of an encryption/decryption engine, an encode/decode engine, a compression/decompression engine, or a combination thereof.

### Example 9

This example includes any or all of the features of any one of examples 1 to 8, wherein the accelerated operations include at least a portion of encrypting the data, decrypting the data, encoding the data, decoding the data, compressing the data, and decompressing the data, or a combination thereof.

### Example 10

This example includes any or all of the features of any one of examples 1 to 9, wherein: the at least one solid state drive includes a plurality of solid state drives in a solid state drive array, the plurality of solid state drives including at least a first solid state drive and a second solid state drive; the first solid state drive includes a first controller, a first hardware acceleration engine, and first non-volatile memory; the second solid state drive includes a second controller, a second hardware acceleration engine, and second non-volatile memory; the first controller is configured to transmit, in response to receipt of a job execution command from a server, first data associated with the job execution command to the first hardware acceleration engine for execution of first accelerated operations on the first data without storing a first output of the first accelerated operations in the first non-volatile memory; and the second controller is configured to transmit, in response to receipt of a job execution command from a server, second data associated with the job execution command to the second hardware acceleration engine for execution of second accelerated operations on the second data without storing a second output of the second accelerated operations in the second non-volatile memory; and the first and second controllers are configured to provide the first and second outputs, respectively, to the server.

### Example 11

This example includes any or all of the features of example 10, wherein: the first and second solid state drive respectively include a first transfer buffer and a second transfer buffer; the first controller is further configured to cause the first hardware acceleration engine to store the first output in the first transfer buffer; the second controller is further configured to cause the second hardware acceleration engine to store the second output in the second transfer buffer; and the first controller is further configured to provide the first output to the server in response to receipt of a first request output message from the server; and the second controller is further configured to provide the second output to the server in response to receipt of a second request output message from the server.

### Example 12

This example includes any or all of the features of any one of examples 10 or 11, wherein the first and second controllers are further configured to cause the first and second hardware acceleration engines, respectively to perform the first and second accelerated operations in accordance with parameters of a job to be accelerated.

### Example 13

This example includes any or all of the features of any one of examples 10 to 12, wherein the parameters include at least one of the following: a size of the data, one or more operations to be performed on the data, combinations thereof, and the like.

### Example 14

This example includes any or all of the features of any one of examples 10 to 13, wherein at least one of the first and second solid state drives is included in a solid state drive array that is remote from the server.

### Example 15

This example includes any or all of the features of any one of examples 10 to 14, wherein the at least one of the first and second solid state drives is integral with the server.

### Example 16

This example includes any or all of the features of any one of examples 10 to 15, wherein the first and second controllers are configured to automatically provide the first and second outputs, respectively, to the server.

### Example 17

This example includes any or all of the features of any one of examples 10 to 16, wherein the first hardware acceleration engine and second hardware acceleration engine are each selected from the group consisting of an encryption/decryption engine, an encode/decode engine, a compression/decompression engine, or a combination thereof.

### Example 18

This example includes any or all of the features of any one of examples 10 to 17, wherein: the first accelerated operations include at least a portion of encrypting the first portion of the data, decrypting the first portion of the data, encoding the first portion of the data, decoding the first portion of the data, compressing the first portion of the data, decompressing the first portion of the data, or a combination thereof; and the second accelerated operations include at least a portion of encrypting the second portion of the data, decrypting the second portion of the data, encoding the second portion of the data, decoding the second portion of the data, compressing the second portion of the data, decompressing the second portion of the data, or a combination thereof.

### Example 19

According to this example there is provided a method for accelerating compute intensive operations, including, with a controller of a solid state drive: transmitting, in response to receiving a job execution command from a server, data associated with the job execution command to a hardware acceleration engine of the solid state drive for execution of accelerated operations; performing the accelerated operations one the data with the hardware acceleration engine to produce an output without storing the output in non-volatile memory of the solid state drive; and providing the output to the server.

### Example 20

This example includes any or all of the features of example 19, wherein the solid state drive further includes a transfer buffer, and the method further includes, with the controller: causing the hardware acceleration engine to store the output in the transfer buffer; and providing the output to the server in response to receipt of a request output message from the server.

### Example 21

This example includes any or all of the features of any one of examples 19 and 20, and further includes, with the controller: causing the hardware acceleration engine to perform the accelerated operations in accordance with parameters of a job to be accelerated.

### Example 22

This example includes any or all of the features of any one of examples 19 to 21, wherein the parameters include at least one of the following: a size of the data, one or more operations to be performed on the data, combinations thereof, and the like.

### Example 23

This example includes any or all of the features of any one of examples 19 to 22, wherein the solid state drive is included in a solid state drive array that is remote from the server.

### Example 24

This example includes any or all of the features of any one of examples 19 to 23, wherein the solid state drive is integral with the server.

### Example 25

This example includes any or all of the features of any one of examples 19 to 24, and further includes automatically providing the output to the server.

### Example 26

This example includes any or all of the features of any one of examples 19 to 25, wherein the hardware acceleration engine is selected from the group consisting of an encryption/decryption engine, an encode/decode engine, a compression/decompression engine, or a combination thereof.

### Example 27

This example includes any or all of the features of any one of examples 19 to 26, wherein the accelerated operations include at least a portion of encrypting the data, decrypting the data, encoding the data, decoding the data, compressing the data, and decompressing the data, or a combination thereof.

### Example 28

This example includes any or all of the features of any one of examples 19 to 27, wherein: the solid state drive includes a plurality of solid state drives in a solid state drive array, the plurality of solid state drives including at least a first solid state drive and a second solid state drive, the first solid state drive including a first controller, a first hardware acceleration engine, and first non-volatile memory, the second solid state drive including a second controller, a second hardware acceleration engine, and second non-volatile memory; the method further includes, in response to receipt of the job execution command: with the first controller, transmit first data associated with the job execution command to the first hardware acceleration engine for execution of first accelerated operations on the first data without storing a first output of the first accelerated operations in the first non-volatile memory; with the second controller, transmit second data associated with the job execution command to the second hardware acceleration engine for execution of second accelerated operations on the second data without storing a second output of the second accelerated operations in the second non-volatile memory; and providing the first and second outputs to the server with the first and second controllers, respectively.

### Example 29

This example includes any or all of the features of example 28, wherein the first and second solid state drives respectively include a first transfer buffer and a second transfer buffer, and the method further includes: causing the first hardware acceleration engine to store the first output in the first transfer buffer; causing the second hardware acceleration engine to store the second output in the second transfer buffer; and in response to at least one output request message from the server, providing at least one of the first and second output to the server.

### Example 30

This example includes any or all of the features of any one of examples 28 and 29, and further includes: with the first controller, causing the first hardware acceleration engine to perform the first accelerated operations in accordance with parameters of a job to be accelerated; and with the second controller, causing the second hardware acceleration engine to perform the second accelerated operations in accordance with the parameters.

### Example 31

This example includes any or all of the features of any one of examples 28 to 30, wherein the parameters include at least one of the following: a size of the data, one or more operations to be performed on the data, combinations thereof, and the like.

### Example 32

This example includes any or all of the features of any one of examples 28 to 31, wherein at least one of the first and second solid state drives is included in a solid state drive array that is remote from the server.

### Example 33

This example includes any or all of the features of any one of examples 28 to 32, wherein at least one of the first and second solid state drives is integral with the server.

### Example 34

This example includes any or all of the features of any one of examples 28 to 33, and further includes automatically providing the first and second outputs to the server with the first and second controllers, respectively.

### Example 35

This example includes any or all of the features of any one of examples 28 to 34, wherein the first hardware acceleration engine and second hardware acceleration engine are each selected from the group consisting of an encryption/decryption engine, an encode/decode engine, a compression/decompression engine, or a combination thereof.

### Example 36

This example includes any or all of the features of any one of examples 28 to 35, wherein: the first accelerated operations include at least a portion of encrypting the first portion of the data, decrypting the first portion of the data, encoding the first portion of the data, decoding the first portion of the data, compressing the first portion of the data, decompressing the first portion of the data, or a combination thereof; and the second accelerated operations include at least a portion of encrypting the second portion of the data, decrypting the second portion of the data, encoding the second portion of the data, decoding the second portion of the data, compressing the second portion of the data, decompressing the second portion of the data, or a combination thereof.

### Example 37

According to this example there is provided at least one computer readable medium having computer readable instructions stored thereon, wherein the instructions when executed by a controller of a solid state drive cause the performance of the following operations including: transmitting, in response to receiving a job execution command from a server, data associated with the job execution command to a hardware acceleration engine of the solid state drive for execution of accelerated operations; performing the accelerated operations one the data with the hardware acceleration engine to produce an output without storing the output in non-volatile memory of the solid state drive; and providing the output to the server

### Example 38

This example includes any or all of the features of example 37, wherein the solid state drive further includes a transfer buffer and the instructions when executed by the controller further cause the performance of the following operations including: causing the hardware acceleration engine to store the output in the transfer buffer; and providing the output to the server in response to receipt of a request output message from the server.

### Example 39

This example includes any or all of the features of any one of examples 37 and 38, wherein the instructions when executed by the controller further cause the performance of the following operations including: causing the hardware acceleration engine to perform the accelerated operations in accordance with parameters of a job to be accelerated.

### Example 40

This example includes any or all of the features of any one of examples 37 to 39, wherein the parameters include at least one of the following: a size of the data, one or more operations to be performed on the data, combinations thereof, and the like.

### Example 41

This example includes any or all of the features of any one of examples 37 to 40, wherein the solid state drive is included in a solid state drive array that is remote from the server.

### Example 42

This example includes any or all of the features of any one of examples 37 to 41, wherein the solid state drive is integral with the server.

### Example 43

This example includes any or all of the features of any one of examples 37 to 42, wherein the instructions when executed by the controller further cause the performance of the following operations including: automatically providing the output to the server.

### Example 44

This example includes any or all of the features of any one of examples 37 to 43, wherein the hardware acceleration engine is selected from the group consisting of an encryption/decryption engine, an encode/decode engine, a compression/decompression engine, or a combination thereof.

### Example 45

This example includes any or all of the features of any one of examples 37 to 44, wherein the accelerated operations include at least a portion of encrypting the data, decrypting the data, encoding the data, decoding the data, compressing the data, and decompressing the data, or a combination thereof.

### Example 46

This example includes any or all of the features of any one of examples 37 to 45, wherein: the solid state drive includes a plurality of solid state drives in a solid state drive array, the plurality of solid state drives including at least a first solid state drive and a second solid state drive, the first solid state drive including a first controller, a first hardware acceleration engine, and first non-volatile memory, the second solid state drive including a second controller, a second hardware acceleration engine, and second non-volatile memory; the instructions when executed by the first and second controllers further cause the performance of the following operations including: with the first controller, transmitting first data associated with the job execution command to the first hardware acceleration engine for execution of first accelerated operations on the first data without storing a first output of the first accelerated operations in the first non-volatile memory; with the second controller, transmitting second data associated with the job execution command to the second hardware acceleration engine for execution of second accelerated operations on the second data without storing a second output of the second accelerated operations in the second non-volatile memory; and providing the first and second outputs to the server with the first and second controllers, respectively.

### Example 47

This example includes any or all of the features of example 46, wherein the first and second solid state drives respectively include a first transfer buffer and a second transfer buffer, and the instructions when executed by the first and second controllers further cause the performance of the following operations including: causing the first hardware acceleration engine to store the first output in the first transfer buffer; causing the second hardware acceleration engine to store the second output in the second transfer buffer; and in response to at least one output request message from the server, providing at least one of the first and second output to the server.

### Example 48

This example includes any or all of the features of any one of examples 46 and 47, wherein the instructions when executed by the first and second controllers further cause the performance of the following operations including: with the first controller, causing the first hardware acceleration engine to perform the first accelerated operations in accordance with parameters of a job to be accelerated; and with the second controller, causing the second hardware acceleration engine to perform the second accelerated operations in accordance with the parameters.

### Example 49

This example includes any or all of the features of any one of examples 46 to 48, wherein the parameters include at least one of the following: a size of the data, one or more operations to be performed on the data, combinations thereof, and the like.

### Example 50

This example includes any or all of the features of any one of examples 46 to 49, wherein at least one of the first and second solid state drives is included in a solid state drive array that is remote from the server.

### Example 51

This example includes any or all of the features of any one of examples 46 to 50, wherein at least one of the first and second solid state drives is integral with the server.

### Example 52

This example includes any or all of the features of any one of examples 46 to 51, wherein the instructions when executed by the first and second controllers further cause the performance of the following operations including: automatically providing the first and second outputs to the server with the first and second controllers, respectively.

### Example 53

This example includes any or all of the features of any one of examples 46 to 52, wherein the first hardware acceleration engine and second hardware acceleration engine are each selected from the group consisting of an encryption/decryption engine, an encode/decode engine, a compression/decompression engine, or a combination thereof.

### Example 54

This example includes any or all of the features of any one of examples 46 to 53, wherein: the first accelerated operations include at least a portion of encrypting the first portion of the data, decrypting the first portion of the data, encoding the first portion of the data, decoding the first portion of the data, compressing the first portion of the data, decompressing the first portion of the data, or a combination thereof; and the second accelerated operations include at least a portion of encrypting the second portion of the data, decrypting the second portion of the data, encoding the second portion of the data, decoding the second portion of the data, compressing the second portion of the data, decompressing the second portion of the data, or a combination thereof.

### Example 55

According to this example there is provided at least one computer readable medium including computer readable instructions which when executed by a controller of at least one solid state disk cause the performance of the method of any one of examples 19 to 36.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system for accelerating compute intensive operations comprising:
at least one solid state drive comprising a controller, a hardware acceleration engine, and non-volatile memory, wherein the controller is configured to:
transmit, in response to receipt of a job execution command from a server, data associated with the job execution command to the hardware acceleration engine for execution of accelerated operations on said data without storing an output of said accelerated operations in said non-volatile memory; and
provide said output to said server.

2. The system of claim 1, wherein:
said at least one solid state drive further comprises a transfer buffer;
said controller is further configured to cause the hardware acceleration engine to store said output in said transfer buffer; and
said controller is further configured to provide said output to said server in response to receipt of a request output message from said server.

3. The system of claim 1, wherein said controller is further configured to cause the hardware acceleration engine to perform said accelerated operations in accordance with parameters of a job to be accelerated.

4. The system of claim 3, wherein said parameters include at least one of the following: a size of the data, one or more operations to be performed on the data, combinations thereof, and the like.

5. The system of claim 1, wherein the at least one solid state drive is included in an solid state drive array that is remote from the server.

6. The system of claim 1, wherein the at least one solid state drive is integral with said server.

7. The system of claim 1, wherein the controller is configured to automatically provide said output to said server.

8. The system of claim 1, wherein said hardware acceleration engine is selected from the group consisting of an encryption/decryption engine, an encode/decode engine, a compression/decompression engine, or a combination thereof.

9. The system of claim 1, wherein said accelerated operations comprise at least a portion of encrypting said data, decrypting said data, encoding said data, decoding said data, compressing said data, and decompressing said data, or a combination thereof.

10. A method for accelerating compute intensive operations, comprising, with a controller of a solid state drive:
transmitting, in response to receiving a job execution command from a server, data associated with the job execution command to a hardware acceleration engine of the solid state drive for execution of accelerated operations;
performing said accelerated operations one said data with said hardware acceleration engine to produce an output without storing the output in non-volatile memory of said solid state drive; and
providing said output to said server.

11. The method of claim 10, wherein said solid state drive further comprises a transfer buffer, and the method further comprises, with said controller:
causing said hardware acceleration engine to store said output in said transfer buffer; and
providing said output to said server in response to receipt of a request output message from said server.

12. The method of claim 10, further comprising, with said controller:
causing said hardware acceleration engine to perform said accelerated operations in accordance with parameters of a job to be accelerated.

13. The method of claim 11, wherein said parameters include at least one of the following: a size of the data, one or more operations to be performed on the data, combinations thereof, and the like.

14. The method of claim 10, wherein the solid state drive is included in a solid state drive array that is remote from the server.

15. The method of claim 10, wherein the solid state drive is integral with the server.

16. The method of claim 10, further comprising automatically providing said output to said server.

17. The method of claim 10, wherein said hardware acceleration engine is selected from the group consisting of an encryption/decryption engine, an encode/decode engine, a compression/decompression engine, or a combination thereof.

18. At least one computer readable medium having computer readable instructions stored thereon, wherein said instructions when executed by a controller of a solid state drive cause the performance of the following operations comprising:
transmitting, in response to receiving a job execution command from a server, data associated with the job execution command to a hardware acceleration engine of the solid state drive for execution of accelerated operations;
performing said accelerated operations one said data with said hardware acceleration engine to produce an output without storing the output in non-volatile memory of said solid state drive; and
providing said output to said server

19. The at least one computer readable medium of claim 18, wherein said solid state drive further comprises a transfer buffer and said instructions when executed by the controller further cause the performance of the following operations comprising:
causing said hardware acceleration engine to store said output in said transfer buffer; and
providing said output to said server in response to receipt of a request output message from said server.

20. The at least one computer readable medium of claim 18, wherein said instructions when executed by the controller further cause the performance of the following operations comprising:
causing said hardware acceleration engine to perform said accelerated operations in accordance with parameters of a job to be accelerated.

21. The at least one computer readable medium of claim 20, wherein said parameters include at least one of the following: a size of the data, one or more operations to be performed on the data, combinations thereof, and the like.

22. The at least one computer readable medium of claim 18, wherein the solid state drive is included in a solid state drive array that is remote from the server.

23. The at least one computer readable medium of claim 18, wherein the solid state drive is integral with said server.

24. The at least one computer readable medium of claim 18, wherein said instructions when executed by the controller further cause the performance of the following operations comprising:
automatically providing said output to said server.

25. The at least one computer readable medium of claim 18, wherein said hardware acceleration engine is selected from the group consisting of an encryption/decryption engine, an encode/decode engine, a compression/decompression engine, or a combination thereof.
